(19) United States
(12) Patent Application Publication
(10) Pub. No.: US 2002/0181168 A1
(43) Pub. Date: Dec. 5, 2002

(54) Read head with tunnel junction sensor and non-shunting hard bias stabilization

(75) Inventors: Hardayal Singh Gill, Palo Alto, CA (US); Robert Edward Fontana JR., San Jose, CA (US)

Correspondence Address: Ron Feece, INTERNATIONAL BUSINESS MACHINES CORPORATION, Dept. L2PA, 5600 Cottle Road, San Jose, CA, 95193, US

(73) Assignee: International Business Machines Corporation

(21) Appl. No.: 09/874,477

(22) Filed: Jun. 4, 2001

(51) Int. Cl. G11B 5/39

(52) U.S. Cl. 360/324.2

(57) ABSTRACT

First and second longitudinal biasing layers for a free layer of a tunnel junction sensor are electrically insulative so as to not shunt any of the sense current conducted through the tunnel junction sensor. The first and second longitudinal biasing layers are composed of gamma iron oxide (λFe₂O₃).

### BACKGROUND OF THE INVENTION

1. Field of the Invention

The present invention relates to a read head with a tunnel junction sensor and non-shunting hard bias stabilization and, more particularly, to first and second hard bias layers which are composed of gamma iron oxide (λFe₂O₃).

2. Description of the Related Art

The heart of a computer is a magnetic disk drive which includes a rotating magnetic disk, a slider that has read and write heads, a suspension arm above the rotating disk and an actuator arm that swings the suspension arm to place the read and write heads over selected circular tracks on the rotating disk. The suspension arm biases the slider into contact with the surface of the disk when the disk is not rotating but, when the disk rotates, air is swirled by the rotating disk adjacent an air bearing surface (ABS) of the slider causing the slider to ride on an air bearing a slight distance from the surface of the rotating disk. When the slider rides on the air bearing the write and read heads are employed for writing magnetic impressions to and reading magnetic signal fields from the rotating disk. The read and write heads are connected to processing circuitry that operates according to a computer program to implement the writing and reading functions.

An exemplary high performance read head employs a tunnel junction sensor for sensing the magnetic signal fields from the rotating magnetic disk. The sensor includes an insulative tunneling or barrier layer sandwiched between a ferromagnetic pinned layer and a ferromagnetic free layer. An antiferromagnetic pinning layer interfaces the pinned layer for pinning the magnetic moment of the pinned layer 90° to an air bearing surface (ABS) wherein the ABS is an exposed surface of the sensor that faces the rotating disk. The tunnel junction sensor is located between ferromagnetic first and second shield layers. First and second leads, which may be the first and second shield layers, are connected to the tunnel junction sensor for conducting a sense current therethrough. The sense current is conducted perpendicular to the major film planes (CPP) of the sensor as contrasted to a spin valve sensor where the sense current is conducted parallel to or in the major film planes (CIP) of the spin valve sensor. A magnetic moment of the free layer is free to rotate upwardly and downwardly with respect to the ABS from a quiescent or zero bias point position in response to positive and negative magnetic signal fields from the rotating magnetic disk. The quiescent position of the magnetic moment of the free layer, which is preferably parallel to the ABS, is when the sense current is conducted through the sensor without magnetic field signals from the rotating magnetic disk.

When the magnetic moments of the pinned and free layers are parallel with respect to one another the resistance of the tunnel junction sensor to the sense current (I_{S}) is at a minimum and when their magnetic moments are antiparallel the resistance of the tunnel junction sensor to the sense current (I_{S}) is at a maximum. Changes in resistance of the tunnel junction sensor is a function of cos θ, where θ is the angle between the magnetic moments of the pinned and free layers. When the sense current (I_{S}) is conducted through the tunnel junction sensor resistance changes, due to signal fields from the rotating magnetic disk, cause potential changes that are detected and processed as playback signals. The sensitivity of the tunnel junction sensor is quantified as magnetoresistive coefficient dr/R where dr is the change in resistance of the tunnel junction sensor from minimum resistance (magnetic moments of free and pinned layers parallel) to maximum resistance (magnetic moments of the free and pinned layers antiparallel) and R is the resistance of the tunnel junction sensor at minimum resistance. The dr/R of a tunnel junction sensor can be on the order of 40% as compared to 10% for a spin valve sensor.

The first and second shield layers may engage the bottom and the top respectively of the tunnel junction sensor so that the first and second shield layers may serve as leads for conducting the sense current I_{S} through the tunnel junction sensor perpendicular to the major planes of the layers of the tunnel junction sensor.

The tunnel junction sensor has first and second side edges which are normal to the ABS. First and second hard bias layers abut the first and second side edges respectively of the tunnel junction sensor for longitudinally biasing the magnetic domains of the free layer. This longitudinal biasing maintains the magnetic moment of the free layer parallel to the ABS when the read head is in a quiescent condition. Unfortunately, prior art hard biasing layers for tunnel junction sensors have an undesirable degree of electrical conductivity which shunts the sense current as it is conducted perpendicular to the major planes of the layers of the tunnel junction sensor. There is a strong-felt need to overcome this problem since the shunting of the sense current results in a reduction of the magnetoresistive coefficient dr/R of the tunnel junction sensor.

### SUMMARY OF THE INVENTION

The present invention provides a read head with non-shunting longitudinal hard biasing layers for a tunnel junction sensor. The non-shunting hard bias layers of the present invention are composed of gamma iron oxide (λFe₂O₃). The first and second hard bias layers of the present invention abut the first and second side edges of the tunnel junction sensor for performing the aforementioned longitudinal biasing of the magnetic spins of the free layer in the tunnel junction sensor without shunting the sense current I_{S} conducted therethrough.

An object of the present invention is to provide a read head which has a tunnel junction sensor and non-shunting longitudinal biasing layers.

Other objects and attendant advantages of the invention will be appreciated upon reading the following description taken together with the accompanying drawings.

### BRIEF DESCRIPTION OF THE DRAWINGS

FIG. 1 is a plan view of an exemplary magnetic disk drive;

FIG. 2 is an end view of a slider with a magnetic head of the disk drive as seen in plane 2-2 of FIG. 1;

FIG. 3 is an elevation view of the magnetic disk drive wherein multiple disks and magnetic heads are employed;

FIG. 4 is an isometric illustration of an exemplary suspension system for supporting the slider and magnetic head;

FIG. 5 is an ABS view of the magnetic head taken along plane 5-5 of FIG. 2;

FIG. 6 is a partial view of the slider and a piggyback magnetic head as seen in plane 6-6 of FIG. 2;

FIG. 7 is a partial view of the slider and a merged magnetic head as seen in plane 7-7 of FIG. 2;

FIG. 8 is a partial ABS view of the slider taken along plane 8-8 of FIG. 6 to show the read and write elements of the piggyback magnetic head;

FIG. 9 is a partial ABS view of the slider taken along plane 9-9 of FIG. 7 to show the read and write elements of the merged magnetic head;

FIG. 10 is a view taken along plane 10-10 of FIG. 6 or 7 with all material above the coil layer and leads removed; and

FIG. 11 is an enlarged ABS illustration of the tunnel junction read head.

### DESCRIPTION OF THE PREFERRED EMBODIMENTS

### Magnetic Disk Drive

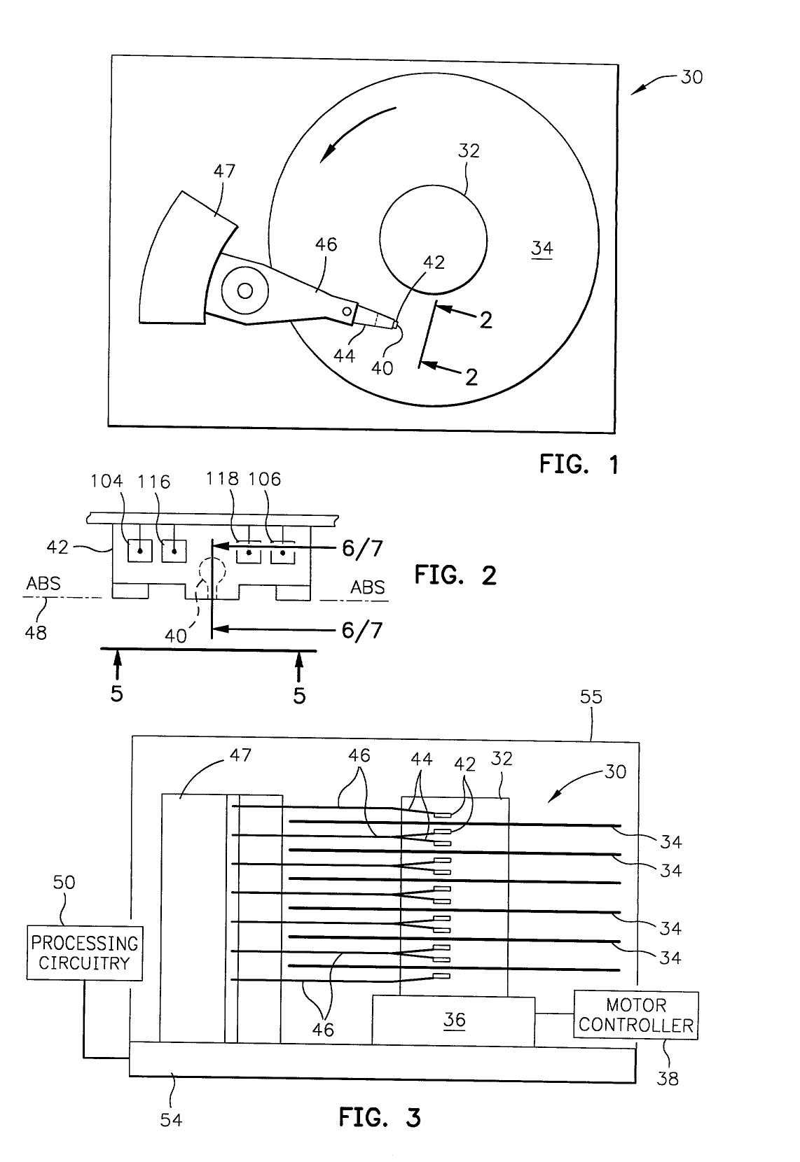

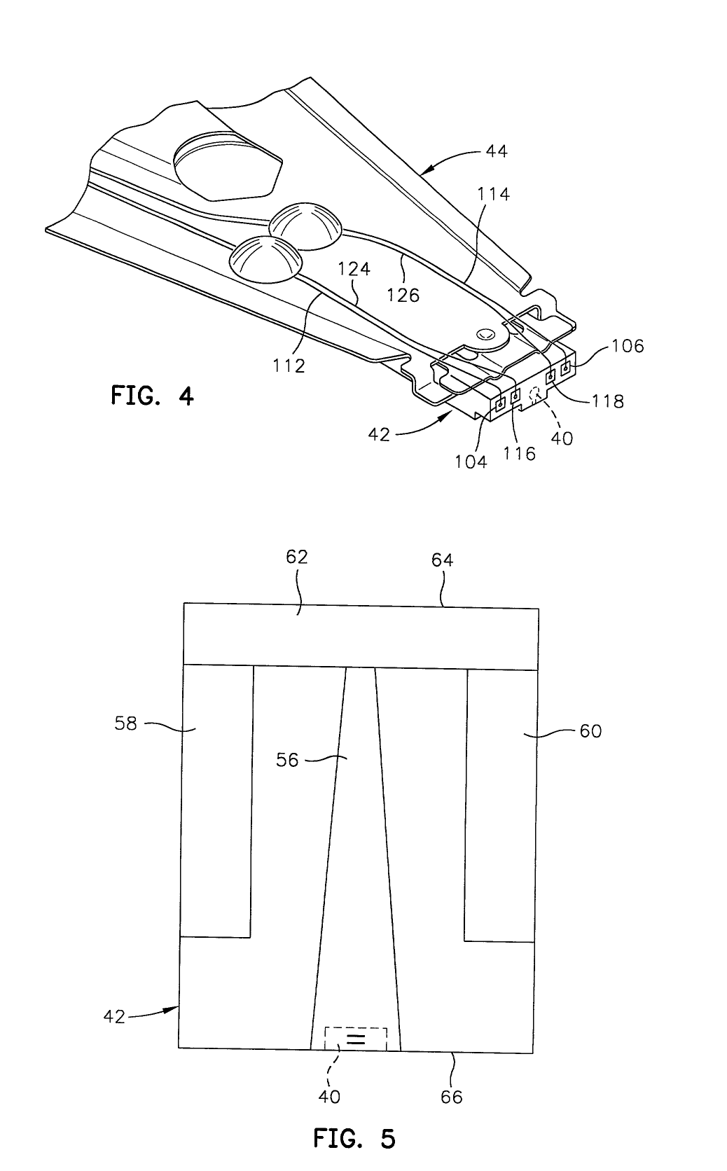

Referring now to the drawings wherein like reference numerals designate like or similar parts throughout the several views, FIGS. 1-3 illustrate a magnetic disk drive 30. The drive 30 includes a spindle 32 that supports and rotates a magnetic disk 34. The spindle 32 is rotated by a spindle motor 36 that is controlled by a motor controller 38. A slider 42 has a combined read and write magnetic head 40 and is supported by a suspension 44 and actuator arm 46 that is rotatably positioned by an actuator 47. A plurality of disks, sliders and suspensions may be employed in a large capacity direct access storage device (DASD) as shown in FIG. 3. The suspension 44 and actuator arm 46 are moved by the actuator 47 to position the slider 42 so that the magnetic head 40 is in a transducing relationship with a surface of the magnetic disk 34. When the disk 34 is rotated by the spindle motor 36 the slider is supported on a thin (typically, 0.05 μm) cushion of air (air bearing) between the surface of the disk 34 and the air bearing surface (ABS) 48. The magnetic head 40 may then be employed for writing information to multiple circular tracks on the surface of the disk 34, as well as for reading information therefrom. Processing circuitry 50 exchanges signals, representing such information, with the head 40, provides spindle motor drive signals for rotating the magnetic disk 34, and provides control signals to the actuator for moving the slider to various tracks. In FIG. 4 the slider 42 is shown mounted to a suspension 44. The components described hereinabove may be mounted on a frame 54 of a housing, as shown in FIG. 3.

FIG. 5 is an ABS view of the slider 42 and the magnetic head 40. The slider has a center rail 56 that supports the magnetic head 40, and side rails 58 and 60. The rails 56, 58 and 60 extend from a cross rail 62. With respect to rotation of the magnetic disk 34, the cross rail 62 is at a leading edge 64 of the slider and the magnetic head 40 is at a trailing edge 66 of the slider.

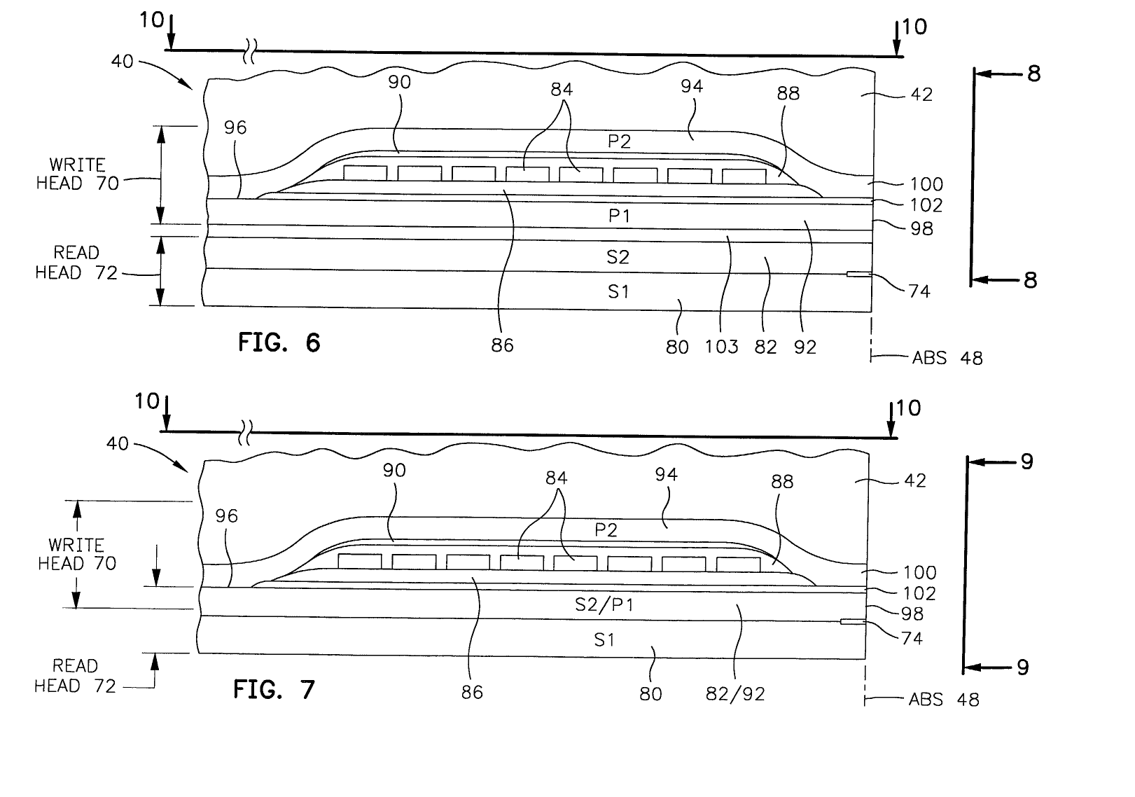

FIG. 6 is a side cross-sectional elevation view of a piggyback magnetic head 40, which includes a write head portion 70 and a read head portion 72, the read head portion employing a tunnel junction sensor 74 of the present invention. FIG. 8 is an ABS view of FIG. 6. The tunnel junction sensor 74 is sandwiched between ferromagnetic first and second shield layers 80 and 82. In response to external magnetic fields, the resistance of the spin valve sensor 74 changes. A sense current (I_{S}) conducted through the sensor causes these resistance changes to be manifested as potential changes. These potential changes are then processed as readback signals by the processing circuitry 50 shown in FIG. 3. The sense current (I_{S}) may be conducted through the tunnel junction sensor 74 perpendicular to the planes of its film surfaces by the first and second shield layers 80 and 82 which serve as first and second leads.

The write head portion 70 of the magnetic head 40 includes a coil layer 84 sandwiched between first and second insulation layers 86 and 88. A third insulation layer 90 may be employed for planarizing the head to eliminate ripples in the second insulation layer caused by the coil layer 84. The first, second and third insulation layers are referred to in the art as an “insulation stack”. The coil layer 84 and the first, second and third insulation layers 86, 88 and 90 are sandwiched between first and second pole piece layers 92 and 94. The first and second pole piece layers 92 and 94 are magnetically coupled at a back gap 96 and have first and second pole tips 98 and 100 which are separated by a write gap layer 102 at the ABS. An insulation layer 103 is located between the second shield layer 82 and the first pole piece layer 92. Since the second shield layer 82 and the first pole piece layer 92 are separate layers this head is known as a piggyback head. As shown in FIGS. 2 and 4, first and second solder connections 104 and 106 connect leads from the spin valve sensor 74 to leads 112 and 114 on the suspension 44, and third and fourth solder connections 116 and 118 connect leads 120 and 122 from the coil 84 (see FIG. 10) to leads 124 and 126 on the suspension.

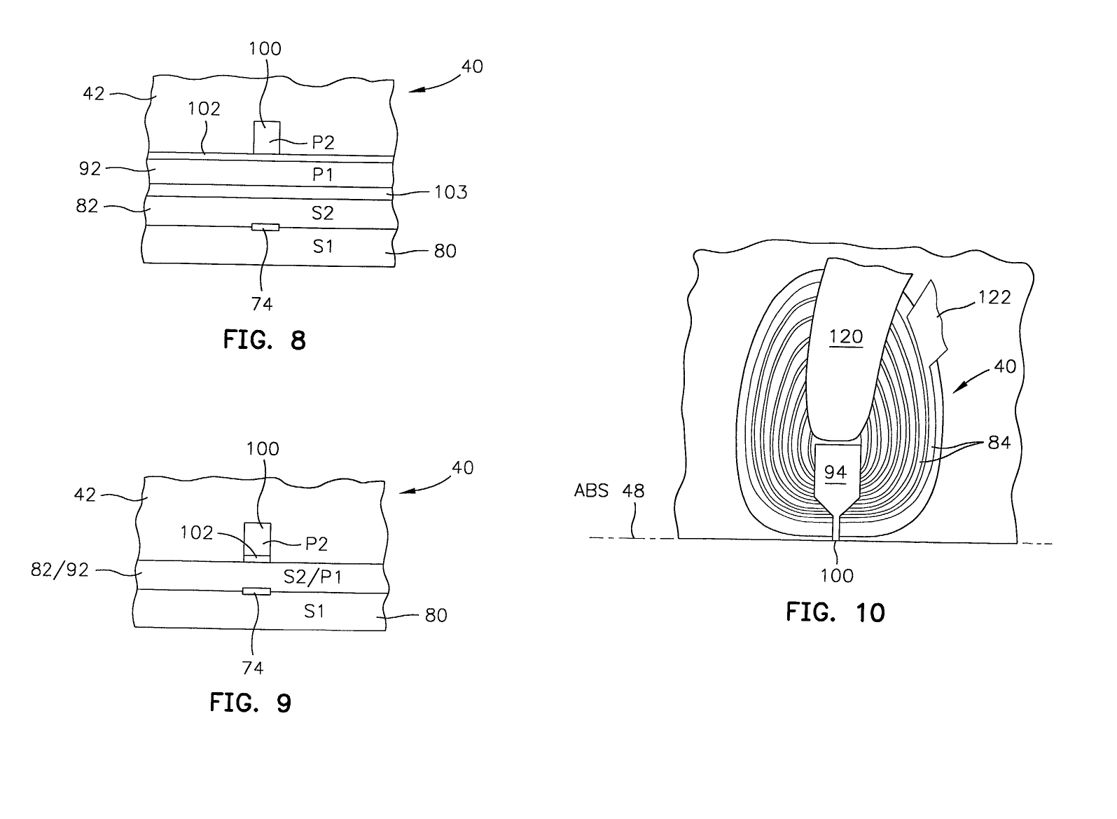

FIGS. 7 and 9 are the same as FIGS. 6 and 8 except the second shield layer 82 and the first pole piece layer 92 are a common layer. This type of head is known as a merged magnetic head. The insulation layer 103 of the piggyback head in FIGS. 6 and 8 is omitted.

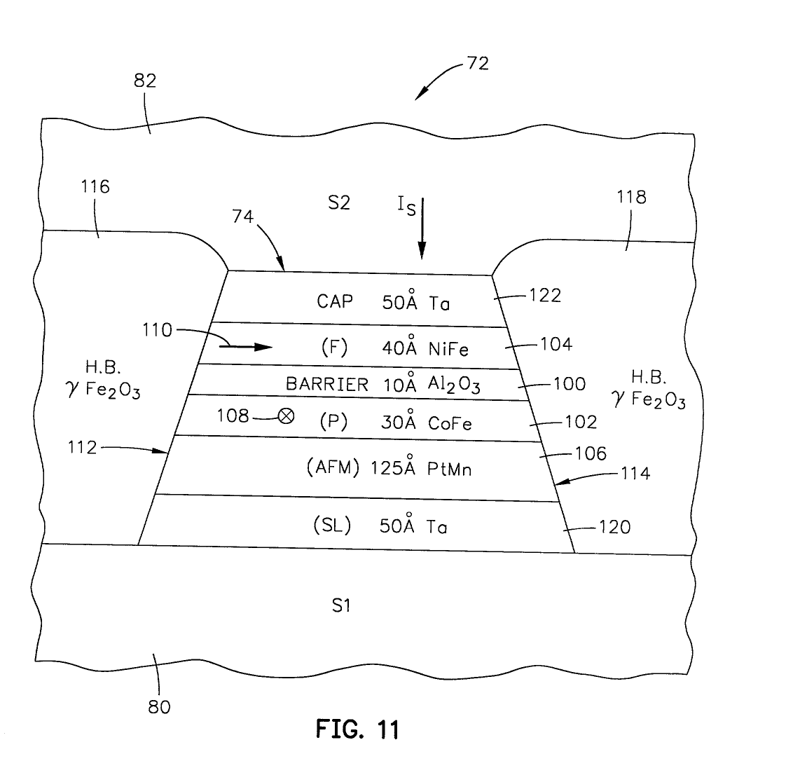

FIG. 11 is an enlarged ABS illustration of the present read head 72 with the tunnel junction 74 located between the first and second shield layers 80 and 82. The tunnel junction sensor 74 includes a nonmagnetic electrically insulative barrier layer 100 which is located between the pinned layer (P) 102 and a ferromagnetic free layer (F) 104. An antiferromagnetic pinning layer (AFM) 106 is exchange coupled to the pinned layer 102 for pinning a magnetic moment 108 of the pinned layer perpendicular to the ABS in a direction either out of the read head or into the read head, as shown in FIG. 11. The free layer 104 has a magnetic moment 110 which is oriented parallel to the ABS and the major planes of the layers in a direction from either right to left or from left to right, as shown in FIG. 11. When a signal field from a rotating magnetic disk rotates the magnetic moment 110 of the free layer into the head the magnetic moments 110 and 108 become more parallel which reduces the resistance of the tunnel junction sensor to a sense current Iₛ and when the field signal from the rotating magnetic disk rotates the magnetic moment 110 out of the read head magnetic moments 110 and 108 become more antiparallel which increases the resistance of the tunnel junction sensor to the sense current Iₛ. These changes in resistance are processed as playback signals by the processing circuitry 50 in FIG. 3.

The tunnel junction sensor 74 has first and second side surfaces 112 and 114 which are perpendicular to the ABS and extend into the read head. First and second hard bias layers (HB) 116 and 118 abut the first and second side surfaces 112 and 114 of the tunnel junction sensor for the purpose of longitudinally biasing the magnetic domains of the free layer 104. In the present invention each of the hard bias layers 116 and 118 are composed of gamma iron oxide (λFe₂O₃). The gamma iron oxide is magnetic for the purpose of longitudinally biasing the free layer 104 but is electrically insulative so that it will not shunt any of the sense current Iₛ conducted through the tunnel junction sensor 74. A seed layer (SL) 120 may be employed between the layers 80 and 106 and a cap layer 122 may be employed between the layers 104 and 82.

Exemplary thicknesses of the layers of the tunnel junction sensor 74 are 50 Å of tantalum for the seed layer 120, 125 Å of platinum manganese for the pinning layer 106, 30 Å of cobalt iron for the pinned layer 102, 10 Å of aluminum oxide (Al₂O₃) for the barrier layer 100, 40 Å of nickel iron for the free layer 104 and 50 Å of tantalum for the cap layer 122.

### Discussion

It should be understood that the thicknesses and materials of the layers other than the material of the hard bias layers are exemplary. The cobalt iron is preferably Co₉₀Fe₁₀, the nickel iron is preferably Ni₈₃Fe₁₇ and the platinum manganese is preferably Pt₅₀Mn₅₀. It should be understood that cobalt may be substituted for the cobalt iron and nickel manganese or iridium manganese may be substituted for the platinum manganese.

Clearly, other embodiments and modifications of this invention will occur readily to those of ordinary skill in the art in view of these teachings. Therefore, this invention is to be limited only by the following claims, which include all such embodiments and modifications when viewed in conjunction with the above specification and accompanying drawings.

I claim:

1. A magnetic read head which has an air bearing surface (ABS), comprising:
a tunnel junction sensor including:
a ferromagnetic pinned layer that has a magnetic moment;
an antiferromagnetic pinning layer exchange coupled to the pinned layer for pinning the magnetic moment of the pinned layer;
a ferromagnetic free layer which has a magnetic moment;
a nonmagnetic electrically insulative barrier layer located between the free layer and the pinned layer; and
the tunnel junction sensor having first and second side edges which extend from the ABS into the read head;
first and second hard bias layers abutting the first and second side edges respectively of the tunnel junction sensor; and
each of the first and second hard bias layers being composed of λFe₂O₃.

2. A magnetic read head as claimed in claim 1 including:
ferromagnetic first and second shield layers; and
the tunnel junction sensor being located between the first and second shield layers.

3. A magnetic head assembly having an air bearing surface (ABS), comprising:
a write head including:
ferromagnetic first and second pole piece layers that have a yoke portion located between a pole tip portion and a back gap portion;
a nonmagnetic write gap layer located between the pole tip portions of the first and second pole piece layers;
an insulation stack with at least one coil layer embedded therein located between the yoke portions of the first and second pole piece layers; and
the first and second pole piece layers being connected at their back gap portions; and
a read head including:
a first shield layer;
a tunnel junction sensor located between the first shield layer and the first pole piece layer;
the tunnel junction sensor including:
a ferromagnetic pinned layer that has a magnetic moment;
an antiferromagnetic pinning layer exchange coupled to the pinned layer for pinning the magnetic moment of the pinned layer;
a ferromagnetic free layer which has a magnetic moment; and
a nonmagnetic electrically insulative barrier layer located between the free layer and the pinned layer;
the tunnel junction sensor having first and second side edges which extend from the ABS into the tunnel junction sensor;
first and second hard bias layers abutting the first and second side edges respectively of the tunnel junction sensor; and
each of the first and second hard bias layers being composed of λFe₂O₃.

4. A magnetic head assembly as claimed in claim 3 including:
a ferromagnetic second shield layer;
a nonmagnetic isolation layer located between the second shield layer and the first pole piece layer.

5. A magnetic disk drive including at least one magnetic head assembly that has an a write head, a read head and an air bearing surface (ABS) comprising:
the write head including:
ferromagnetic first and second pole piece layers that have a yoke portion located between a pole tip portion and a back gap portion;
a nonmagnetic write gap layer located between the pole tip portions of the first and second pole piece layers;
an insulation stack with at least one coil layer embedded therein located between the yoke portions of the first and second pole piece layers; and
the first and second pole piece layers being connected at their back gap portions; and
the read head including:
a first shield layer;
a tunnel junction sensor located between the first shield layer and the first pole piece layer;
the tunnel junction sensor including:
a ferromagnetic pinned layer that has a magnetic moment;
an antiferromagnetic pinning layer exchange coupled to the pinned layer for pinning the magnetic moment of the pinned layer;
a ferromagnetic free layer which has a magnetic moment;
a nonmagnetic electrically insulative barrier layer located between the free layer and the pinned layer; and
the tunnel junction sensor having first and second side edges which extend from the ABS into the tunnel junction sensor;
first and second hard bias layers abutting the first and second side edges respectively of the tunnel junction sensor; and
each of the first and second hard bias layers being composed of λFe₂O₃;
a housing;
a magnetic disk rotatably supported in the housing;
a support mounted in the housing for supporting the magnetic head assembly with said ABS facing the magnetic disk so that the magnetic head assembly is in a transducing relationship with the magnetic disk;
a spindle motor for rotating the magnetic disk;
an actuator positioning means connected to the support for moving the magnetic head assembly to multiple positions with respect to said magnetic disk; and
a processor connected to the magnetic head assembly, to the spindle motor and to the actuator for exchanging signals with the magnetic head assembly, for controlling movement of the magnetic disk and for controlling the position of the magnetic head assembly.

6. A magnetic disk drive as claimed in claim 5 including:
a ferromagnetic second shield layer;
a nonmagnetic isolation layer located between the second shield layer and the first pole piece layer.

7. A method of making a magnetic read head which has an air bearing surface (ABS), comprising the steps of:
making a tunnel junction sensor including the steps of:
forming a ferromagnetic pinned layer with a magnetic moment;
forming an antiferromagnetic pinning layer exchange coupled to the pinned layer for pinning the magnetic moment of the pinned layer;
forming a ferromagnetic free layer with a magnetic moment;
forming a nonmagnetic electrically insulative barrier layer between the free layer and the pinned layer; and
forming the tunnel junction sensor with first and second side edges which extend from the ABS into the tunnel junction sensor;
forming first and second hard bias layers abutting the first and second side edges respectively of the tunnel junction sensor; and
forming each of the first and second hard bias layers of λFe₂O₃.

8. A method of making a magnetic read head as claimed in claim 7 including the steps of:
forming ferromagnetic first and second shield layers; and
forming the tunnel junction sensor between the first and second shield layers.

9. A method of making magnetic head assembly that has an air bearing surface (ABS), comprising the steps of:
making a write head including the steps of:
forming ferromagnetic first and second pole piece layers in pole tip, yoke and back gap regions wherein the yoke region is located between the pole tip and back gap regions;
forming a nonmagnetic nonconductive write gap layer between the first and second pole piece layers in the pole tip region;
forming an insulation stack with at least one coil layer embedded therein between the first and second pole piece layers in the yoke region; and
connecting the first and pole piece layers at said back gap region; and
making a read head including the steps of:
forming a first shield layer; and
forming a tunnel junction sensor between the first shield layer and the first pole piece layer;
a making of the tunnel junction sensor comprising the steps of:
forming a ferromagnetic pinned layer with a magnetic moment;
forming an antiferromagnetic pinning layer exchange coupled to the pinned layer for pinning the magnetic moment of the pinned layer;
forming a ferromagnetic free layer with a magnetic moment;
forming a nonmagnetic electrically insulative barrier layer located between the free layer and the pinned layer; and
forming the tunnel junction sensor with first and second side edges which extend from the ABS into the tunnel junction sensor;
forming first and second hard bias layers abutting the first and second side edges respectively of the tunnel junction sensor; and
forming each of the first and second hard bias layers of λFe₂O₃.

10. A method of making a magnetic head assembly as claimed in claim 9 further including the steps of:
forming a ferromagnetic second shield layer;
forming a nonmagnetic isolation layer between the second shield layer and the first pole piece layer.
